(19) United States
(12) Patent Application Publication
(10) Pub. No.: US 2014/0280706 A1
(43) Pub. Date: Sep. 18, 2014

(54) SYSTEM AND METHOD FOR PRIORITIZING FILE TRANSFER

(71) Applicant: QUALCOMM INCORPORATED, San Diego, CA (US)

(72) Inventors: Nikhil Jain, San Diego, CA (US); Jose R. Menendez, Encinitas, CA (US)

(73) Assignee: QUALCOMM Incorporated, San Diego, CA (US)

(21) Appl. No.: 13/829,931

(22) Filed: Mar. 14, 2013

(51) Int. Cl. H04L 29/08

(52) U.S. Cl. CPC H04L 67/06
USPC 709/217

(57) ABSTRACT

A method for prioritizing file delivery includes capturing content at a sending device, establishing a sending priority for the captured content, sending the captured content when at least one condition is true; and at a receiving device, receiving the captured content when the at least one condition is true.

### DESCRIPTION OF THE RELATED ART

With available mobile device technology, it is becoming common to capture large files. An example of a large file is video content captured using a mobile phone, a video camera, or other mobile video capture device. After capturing the content, it is often desirable to transfer the file between mobile devices. This file transfer is typically done using a variety of methodologies including, for example, email, mobile messaging service (MMS), voice over IP (VoIP) or instant messaging (IM) technology. Unfortunately, MMS is not generally reliable for transferring large files. Various VoIP and IM clients require both parties to be online and give neither party real control of where the content is delivered. For example, the content is typically delivered to whereever the recipient happens to be logged in at that moment. Email has limitations on file size, delivery speed and requires a central repository to store the file until deleted by the user. Streaming or live VoIP sessions can introduce artifacts and are costly when operated over a wide area network (WAN) such as the Internet. Cloud-based storage (e.g. drop box) replicates the functionality of email without many of the limitations making it ideal if it is affordable (e.g. paid premium accounts for large files or frequent use and/or limited accounts for free use because of the limits of ad-based subsidies). Lastly there are other cloud services that involve storage (e.g. YouTube, Facebook, etc.) which have other limitations such as unpredictable or unreliable quality of the transferred content (e.g., Facebook downgrades high resolution pictures) and limited privacy (e.g., users have to manually designate restricted access vs. sharing with all their Facebook “friends”).

Using video as an example, even a short high definition video may consume a large amount of file space. Transferring such a large file using, for example the technologies mentioned above, has numerous limitations. Further, transferring such a large file using a 3G network consumes a large amount of costly bandwidth. Therefore, it would be desirable to have a way to prioritize and control the transfer of large files between a sender and a recipient to allow reliable delivery, and enable lower cost data transfer.

### SUMMARY

An embodiment of a method for prioritizing file delivery includes capturing content at a sending device, establishing a sending priority for the captured content, sending the captured content when at least one condition is true; and at a receiving device, receiving the captured content when the at least one condition is true.

An embodiment of a system for prioritizing file delivery includes a sending device having captured content, a sending priority element configured to assign a sending priority to the captured content, a network over which the captured file traverses when at least one condition is true, and a receiving device configured to receive the captured content when the condition is true.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a block diagram illustrating a first embodiment of a system and method for prioritizing file transfer.

FIG. 2 is a block diagram illustrating example information that may be contained in the database of FIG. 1.

FIG. 3 is a block diagram illustrating an alternative embodiment of a system and method for prioritizing file transfer.

FIG. 4 is a flowchart illustrating an embodiment of a method for prioritizing file transfer.

FIG. 5 is a flowchart illustrating an alternative embodiment of a method for prioritizing file transfer.

FIGS. 6A through 6G are a series diagrams showing of an example of a user interface associated with the system and method for prioritizing file transfer using an exemplary portable device as a sending device.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The system and method for prioritizing file transfer can be implemented in any mobile device that engages in either one way, or bi-directional radio frequency (RF) communication with another mobile or non-mobile device. The system and method for prioritizing file transfer can be implemented in mobile devices that operate over one or more communication networks. As an example, the system and method for prioritizing file transfer can be implemented in a mobile device that operates over RF frequencies referred to as the “Bluetooth” communication band, RF frequencies identified by the IEEE 802.11b/g/n standard, in a mobile device that operates over cellular communication frequencies, and can be implemented in mobile devices that operate on any radio frequency on any type of network.

As used herein, the terms “mobile device” and “mobile communication device” refer to a portable device that can capture content, such as video content, and that can communicate over one or more communication networks. A communication network includes, for example, a 3G, 4G or later cellular communication network, a wide area network (WAN), such as the Internet, a Bluetooth communication network, a wireless fidelity (WiFi) network, or any other communication network.

The terms “low priority network,” and “low cost network” and the terms “high priority” and “high cost network” are relative. The term “low priority network” refers to a high bandwidth network where data transfer is generally less costly than over a “high priority network”. An example of a low priority network is a WiFi network and an example of a high priority network is a cellular network. For example purposes, it is assumed that file transfer over, for example, a WiFi network is less costly than file transfer over, for example, a 3G or 4G cellular network.

FIG. 1 is a block diagram illustrating a first embodiment of a system and method for prioritizing file transfer. The system 100 of FIG. 1 assumes a mode of operation where a sending device and a receiving device communicate directly over one or more communication networks. A system 100 comprises a sending device 102, and a receiving device 132. The sending device 102 and the receiving device 132 can be connected to a network 130. In an embodiment, the network 130 can be a wide area network (WAN), such as the Internet, can be an Intranet, or can be any other wide area network. The sending device 102 can be connected to the network 130 using one or more connections. As an example, the sending device 102 can be connected to the network 130 over a high priority network, such as a cellular-type connection, referred to herein generally as a 3G connection 152, but meant to include any and all high priority networks, such as cellular-type or data connections. The sending device 102 can also be connected separately or simultaneously to the network 130 over a low priority network, such as a wireless fidelity (WiFi) connection 154 via an access point 156. In an embodiment, the access point 156 can be a wireless access point or a wireless router operating in accordance with the IEEE 802.11b/g/n standard. The term WiFi generally denotes a connection established in accordance with an IEEE 802.11b/g/n standard. The term “low priority” network is intended to include WiFi and other wireless connections, such as Bluetooth, infrared (IR) and other connections. The access point 156 can be connected to the network 130 over a connection 158. The connection 158 can include terrestrial wired and wireless connections, as known in the art. Similarly, the receiving device 132 can be connected to the network 130 using one or more connections. As an example, the receiving device 132 can be connected to the network 130 over a high priority network, such as a cellular-type connection, referred to herein generally as a 3G connection 162, but meant to include any and all high priority networks, such as cellular-type connections data connections, and can be connected separately or simultaneously to the network 130 over a low priority network, such as a wireless fidelity (WiFi) connection 164 via an access point 166. In an embodiment, the access point 166 can be a wireless access point or a wireless router operating in accordance with the IEEE 802.11b/g/n standard. The access point 166 can be connected to the network 130 over a connection 168. The connection 168 can include terrestrial wired and wireless connections, as known in the art.

The sending device 102 comprises a processor 104, a transceiver 106, a memory 108, a messaging service 111, and a storage element 113, depicted as a database, operatively coupled together over a communication bus 109. The communication bus 109 can be any physical and/or logical communication infrastructure that allows the connected elements to communication and interoperate. In an embodiment, the sending device 102 can be a smart phone having a video camera or other file capture functionality, a tablet computer having a video camera or other file capture functionality, or the like, and many details of such a device are omitted from this description for simplicity. Those having ordinary skill in the art will understand such devices and their operation. Moreover, a captured video file will be used for illustration purposes only, the captured file can be any captured file. The memory 108 comprises applications 110, a file transfer priority application 112 and content 114. The content 114 can be a captured video 120 that is saved in the memory 108 as a data file. The applications 110 can comprise the operating system and executable software that allow the sending device 102 to operate. In an embodiment, the applications 110 also comprise a graphical user interface 115 that allows a user to interact with the sending device 102.

The receiving device 132 comprises a processor 134, a transceiver 136, a memory 138, a messaging service 141, and a storage element 143, depicted as a database, operatively coupled together over a communication bus 139. The communication bus 139 can be any physical and/or logical communication infrastructure that allows the connected elements to communication and interoperate. In an embodiment, the receiving device 132 can be a smart phone having a video camera or other file capture functionality, a tablet computer having a video camera or other file capture functionality, or the like, and many details of such a device are omitted from this description for simplicity. Those having ordinary skill in the art will understand such devices and their operation. Moreover, a captured video file will be used for illustration purposes only, the captured file can be any captured file. The memory 138 comprises applications 140, a file transfer priority application 142 and content 144. The content 144 can correspond to the content 114 on the sending device 102 or can be content originated at the sending device 132. The applications 140 can comprise the operating system and executable software that allow the receiving device 132 to operate. In an embodiment, the applications 140 also comprise a graphical user interface 145 that allows a user to interact with the receiving device 132.

It is to be understood that the sending device 102 and the receiving device 132 are communication devices that can each connect to a variety of networks either separately or simultaneously, such as, for example only, a 3G/4G wireless network, a WiFi network, or other networks. For purposes of this description, it is assumed that a high priority network, such as a 3G or 4G network is available, but that it is relatively costly and time consuming to transfer a large file, such as the content 114, from the sending device 102 to the receiving device 132 over such a network. Further, conventional file transfer over a 3G or a 4G network does not allow the sending device 102 to uniquely address the file to a specific receiving device. Typically, a 3G or a 4G network allows delivery to an account, such as an email address or a phone number, not to a specific and uniquely addressable device. The file transfer priority application 112 allows a user of the sending device 102 to determine, via one or more priority settings, one or more conditions determining the sending priority and allows content to be sent to a unique address, such as the unique address of the receiving device 132. In an embodiment, the conditions can be chosen from, for example, the availability of a low priority network to either or both of the sending device 102 and to the receiving device 132, over which network or which network type the sending device 102 and the receiving device 132 are connected, and to which specific receiving device to send the content 114 from the sending device 102. It is understood that the terms “sending device” and “receiving device” are interchangeable in that either device can be a sending device and a receiving device.

In an embodiment, the sending device 102 captures the content 114 and a user desires to send the content 114 to the receiving device 132. However, the user of the sending device 102 would prefer to transfer the content 114 to the receiving device 132 when a relatively low priority network, such as a WiFi network, is available for transferring the content 114 from the sending device 102 to the receiving device 132. In such an instance, the user would select a “delay send” or a “low priority” option, thus instructing the file transfer priority application 112 to delay sending the content 114 until a relatively low cost network, such as a WiFi network, is available to both the sending device 102 and to the receiving device 132. As an example, the file transfer priority application 112 can have access to network-layer functionality to allow prioritized delivery using, for example, transmission control protocol (TCP), user datagram protocol (UDP), or other transport methodologies to allow queuing of data that is to be sent when a particular (in this example, a low priority) transport medium is available.

In an embodiment, the file transfer priority application 112 can cause the content 114 to be transferred to the receiving device 132 when a low priority network, such as WiFi network 154 and 164 is available to the sending device 102 and to the receiving device 132. In this example, the sending device 102 and the receiving device 132 coordinate a direct connection 127 over, for example, the 3G network 152 and 162 using, for example, an embedded messaging service 111 and 141, the typical data connection provided by the 3G network 152 and 162, or the like. An embedded messaging service is illustrated as messaging service 111 in the sending device 102, and messaging service 141 in the receiving device 132. Once a connection is established between the sending device 102 and the receiving device 132, the devices exchange information related to whether a low priority network is available between the sending device 102 and the receiving device 132. For example, the sending device 102 can communicate to the receiving device 132 that it is has access to WiFi network 154 and the receiving device 132 can communicate to the sending device 102 that it has access to the WiFi network 164.

When both the sending device 102 and the receiving device 132 are both connected to a WiFi, or other low cost network, the file transfer priority application 112 initiates the transfer of the content 114 from the sending device 102 to the receiving device 132 over the WiFi network 154, network 130 and WiFi network 164. The direct connection is illustrated as a logical connection 129 over which the content 114 is transferred from the sending device 102 to the receiving device 132, where the received content is illustrated as content 144. When a direct connection 127 is established between the sending device 102 and the receiving device 132, the content 114 is transferred directly from the sending device 102 to the receiving device 132 over the WiFi network 154, network 130 and WiFi network 164, without being uploaded to and downloaded from an intermediate system, server, or the like. The content 144 can be viewed on a display 150 on the receiving device 132.

Further, it is possible that the user would like to send the content 114 to a particular receiving device 132 instead of to a location or a log-in address. As an example of the sending device 102 and the receiving device 132 exchanging information related to whether a low priority network is available between the sending device 102 and the receiving device 132, the devices may exchange what can be referred to as a “capability matrix.” The capability matrix can be located on, or can be accessed by a sending device 102 and a receiving device 132, and can be sent to or otherwise communicated to the other device to inform the other device of its capabilities. Such a capability matrix may be contained in the sending device 102 in storage element 113, and in the receiving device 132 in storage element 143, or may be accessible to each device from a database 116 to which the sending device 102 and the receiving device 132 are connected.

FIG. 2 is a block diagram illustrating a capability matrix that can be maintained by, be accessible to, and communicated by the devices of FIG. 1. In an embodiment a capability matrix 202 can be maintained in each device in storage elements 113 and 143, or can be located in the database 116 and may be accessible to a sending device 102 and a receiving device 132. A capability matrix may include an identification table 202 that includes information relating to addresses and capabilities of particular devices. As an example, the table 202 may include what are referred to as “routable addresses” for users and for user devices. For example, the address “Jack.VoIP.personal.tablet” can be an address assigned to a tablet computer belonging to “Jack.” The device ID maps to an Internet Protocol (IP) address 192.168.nnn.nnn corresponding to “Jack.VoIP.personal.tablet”, where the term “nnn” signifies that the address is dependent on a particular network. The table 202 also contains attributes or capabilities of the device associated with the subject device ID. The attributes define the capabilities of the subject device. In this manner, a sending device 102 can enter a routable address in the form of a device ID, IP address, or other unique identifier, of a receiving device 132 and the sending device 102 can know ahead of time whether the receiving device 132 is capable of receiving the content 114.

Moreover, referring to the example of FIG. 1, when a sending device 102 and a receiving device 132 establish an initial connection over a data network, such as connection 127, the devices exchange information related to whether a low priority network is available between the sending device 102 and the receiving device 132. The sending device 102 and the receiving device 132 may also exchange capability matrices so that each device is aware of the other device's capabilities.

FIG. 3 is a block diagram illustrating an alternative embodiment of a system and method for prioritizing file transfer. In FIG. 3, elements that are similar in function to those elements in FIG. 1 have the same reference number and will not be described again in detail. In the embodiment shown in FIG. 3, the sending device 102 captures the content 114 and a user desires to send the content 114 to the receiving device 132. However, the user of the sending device 102 would prefer to transfer the content 114 when a relatively inexpensive low priority network, such as a WiFi network, or other low priority network, is available. In such an instance, the user would select a “delay send” or “low priority” option, thus instructing the file transfer priority application 112 to delay sending the content 114 until a relatively inexpensive network, such as a WiFi network, or other low priority network is available.

In the embodiment shown in FIG. 3, a server 125 is operatively connected to the network 130 over connection 172. The server 125 allows the transfer of the content 114 from the sending device 102 to the receiving device 132 when a direct low priority connection is unavailable between the sending device 102 and the receiving device 132.

In an embodiment, the file transfer priority application 112 can cause the content 114 to be uploaded to the server 125 when a WiFi network 154 is available only to the sending device 102, and then download the content 114 to the receiving device 132, appearing as content 144 in the receiving device 132, when a WiFi network 164 is available to the receiving device 132. In such an application, the content 114 may reside on the server 125 for a period of time.

In this example, when the sending device 102 connects to a WiFi, or other low priority network 154, the file transfer priority application 112 initiates the uploading of the content 114 to the server 125, depicted over logical connection 123, and notifies the receiving device 132 and the file transfer priority application 142, using messaging service 111 and messaging service 141, via high priority connections 152 and 162, that the content 114 is in the server 125. The content 114 then remains on the server 125 until the receiving device 132 is similarly connected to a WiFi, or other low priority network 164. When the receiving device 132 connects to a WiFi, or other low priority network 164, a corresponding file transfer priority application 142 on the receiving device 132 initiates the downloading of the content 114 from the server 125, depicted over logical connection 124, and saves the content as content 144 on the receiving device 132. The content 144 can be viewed on a display 150. In an embodiment, when the sending device 102 transfers the content 114 to the server 125, the sending device can identify, using, for example, a uniform resource locator (URL) or the like, the location on the server 125 where the content 114 resides. The sending device 102 can then forward the URL to the receiving device 132, using, for example, the messaging service 111 and 141, or another methodology, to inform the receiving device 132 of the location of the content 114. Then, when a low priority network, such as WiFi network 164, becomes available to the receiving device 132, the file transfer priority application 142 causes the receiving device 132 to access the server 125 using the URL identifying the location of the content 114 received from the sending device 102 and retrieve the content 114.

The sending device 102 and the receiving device 132 are also each connected to the database 116. The database 116 may be internal to the sending device 102, depicted as storage element 113, and to the receiving device 132, depicted as storage element 143, or may be external to the sending device 102 and the receiving device 132, depicted as database 116. The databases 113, 143, and 116 contain the above-mentioned capability matrices having destination addresses and device capabilities that particularly identify a sending device and a receiving device and the device's capabilities.

FIG. 4 is a flowchart 400 illustrating an embodiment of a method for prioritizing file transfer. The flowchart 400 generally describes the operation of the embodiment depicted in FIG. 1. The blocks in the flowchart are an illustrative embodiment and can be performed in or out of the order shown.

In block 402, a sending device 102 connects to a receiving device 132 over a network, such as a data network over connections 152, and 162, via the network 130.

In block 404, the sending device 102 and the receiving device 132 exchange information relating to the availability of a low priority network to both devices, the identity, attributes, and capabilities of each device, an anticipated time at which each device may have access to a low priority network, and other information. The information can include, for example, the Internet Protocol (IP) address of each device, each device's capabilities and attributes, and other information related to each device.

In block 406, it is determined whether a low priority network is available to each device over which the sending device 102 can transfer the content 114 to the receiving device 132. If it is determined in block 406 that a low priority network is available to each device over which the sending device 102 can transfer the content 114 to the receiving device 132, then, in block 408, the sending device 102 transfers the content 114 to the receiving device 132 and the process ends.

If, however, it is determined in block 406 that a low priority network is not available to each device over which the sending device 102 can transfer the content 114 to the receiving device 132, then, in block 412, it is determined whether a predetermined number of transfer attempts have been exhausted. For example, a predetermined number of transfer attempts can be selected or otherwise applied by the file transfer priority application 112 to allow the sending device 102 to enter into a “wait” or “retry” state. If it is determined in block 412 that the number of attempts has not been exhausted, then the process proceeds to block 414, where the sending device 102 waits a predetermined period of time before again attempting the transfer. The process then returns to block 404. Examples of a predetermined period of time can include a timer or other fixed or user selectable time period, can include waiting until there is an assumption that both the sending device 102 and the receiving device 132 may be have access to a low priority network (for example, when it may be assumed that both devices are located their user's homes and have access to a WiFi, or other low priority network), or other periods of time.

If it is determined in block 412 that the number of attempts has been exhausted, then the process proceeds to block 416, where it is determined if the content should be sent immediately.

If it is determined in block 416 that the content should be sent immediately, the content is sent over whatever network may be available in block 418 and the process ends.

If it determined in block 416 that the content should not be sent immediately, then the process proceeds to block 422 and an indirect transfer may occur and the current process ends. An indirect transfer may include file transfer using a server 125, as described in FIG. 3, and described in greater detail below.

FIG. 5 is a flowchart 500 illustrating an alternative embodiment of a method for prioritizing file transfer. The flowchart 500 generally describes the operation of the embodiment depicted in FIG. 3. The blocks in the flowchart are an illustrative embodiment and can be performed in or out of the order shown. The method described in FIG. 5 may occur after block 422 of FIG. 4, or may occur as an independent method.

In block 502, a sending device 102 connects to a server 125 over a low priority network, such as over the WiFi network 154. The sending device 102 then transfers the content 114 to the server 125 over the WiFi network 154 and network 130. In an embodiment, when the sending device 102 transfers the content 114 to the server 125, the sending device can identify to the receiving device 132, using, for example, a uniform resource locator (URL) or the like, the location on the server 125 where the content 114 resides.

In block 504, the sending device establishes a communication channel with the receiving device 132. The communication channel can be established using a data network, such as the 3G network 152 and 162, can be established using the messaging service 111 and 141, or using another methodology. The sending device 102 then communicates the URL or other identifier identifying to the receiving device 132 the location of the content 114 on the server 125.

In block 506, it is determined whether a low priority network is available to the receiving device 132. If it is determined in block 506 that a low priority network is available over which to transfer the content 114 to the receiving device 132, then, in block 508, the server 125 transfers (or the receiving device 132 retrieves) the content 114 and the process ends.

If, however, it is determined in block 506 that a low priority network is not available to the receiving device 132, then, in block 512, it is determined whether a predetermined number of transfer attempts have been exhausted. For example, a predetermined number of transfer attempts can be selected or otherwise applied by the file transfer priority application 142 to allow the receiving device 132 to enter into a “wait” or “retry” state. If it is determined in block 512 that the number of attempts has not been exhausted, then the process proceeds to block 514, where the receiving device 132 waits a predetermined period of time before again attempting the transfer. The process then returns to block 506.

If it is determined in block 512 that the number of attempts has been exhausted, then the process proceeds to block 516, where it is determined if the content should be delivered immediately.

If it is determined in block 516 that the content should be delivered immediately, the content is delivered over whatever network may be available in block 518 and the process ends.

If it determined in block 516 that the content should not be delivered immediately, then the process proceeds to block 522, where it is determined whether the process should end, or continue to wait. If it determined in block 522 that the process should continue to wait, the process proceeds to block 514.

If, however, it is determined in block 522 that the process should not continue to wait, the process ends.

FIGS. 6A through 6G are a series diagrams showing of an example of a user interface associated with the system and method for prioritizing file transfer using an exemplary portable device 600 as a sending device. The user interface can be an independent application or program running on the device 600, can be part of the operating system of the device 600, can be part of an application that can be installed on the user device, such as a word processing program, a video capture application, or can be any other application.

As an example, the portable device 600 can be used to record and capture video as content 114 (FIGS. 1 and 3), save the content 114 and send the content 114 to a receiving device.

In the example shown in FIG. 6A, the portable device 600 is shown as a smart phone and comprises a display 602. However, the portable device 600 can be any portable device through which content is captured and transferred to another device. In an embodiment, the display 602 comprises a touch screen display that can be used as an information display and as a user input device. However, such a display is shown for illustration purposes only. Other types of portable devices having other types of input and display features and elements can be implemented. The display 602 can be used to display various user interface features and elements. In the example herein, it is assumed that content, such as content 114 (FIGS. 1 and 3) is captured and saved on the portable device 600. In an embodiment, the portable device 600 displays a “find file” menu choice 604 that refers to the ability of a search application or other program on the portable device 600 to locate a saved file. A “Search” button 606 is offered to a user and is used to access files saved on the portable device 600.

In FIG. 6B, when the “Search” button 606 is actuated, a window 607 is displayed showing the content 608 found by the search function. In an embodiment, the content 608 corresponds to the content 114 (FIGS. 1 and 3) and includes an actuation function 609.

In FIG. 6C, the actuation function 609 is actuated and a window 610 is displayed. The window 610 includes a “Send Priority” button 612 and an “Address” button 622.

In FIG. 6D, actuating the “Send Priority” button 612 causes a window 614 to be presented to the user. The window 614 offers a choice of sending priority. In the example shown in FIG. 6D, a “Normal” send button 616 and a “Low Priority” button 618 is offered. If a user actuates the “Low Priority” button 618, then the transfer of the content is delayed until such time that a low priority network is available and the transfer would occur as described above.

In FIG. 6E, the “Address” button 622 has been actuated and is presented on the display 602. When actuated, the “Address” button 622 presents a window 624 having one or more addresses to which the content can be specifically addressed. In the example shown in FIG. 6E, the window 624 contains the addresses 626 and 628, corresponding to “Jack.VoIP.personal.tablet” and “Jack.VoIP.livingroom.tv”, respectively. Although two addresses are illustrated, one address or more than two addresses can be displayed in the window 624.

In FIG. 6F, a user has selected the address “Jack.VoIP.personal.tablet” 626 and is shown a window 632 having a “Confirm” button 634. The “Confirm” button 634 allows a user to confirm the address to which the content will be sent when a suitable low priority network is available.

In FIG. 6G, the display 602 shows the address “Jack.VoIP.personal.tablet” 626 along with an icon 638 stating that the content 114 was or will be sent to that address.

In view of the disclosure above, one of ordinary skill in programming is able to write computer code or identify appropriate hardware and/or circuits to implement the disclosed invention without difficulty based on the associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray Disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for prioritizing file delivery, comprising:
capturing content at a sending device;
establishing a sending priority for the captured content;
sending the captured content when at least one condition is true; and
at a receiving device, receiving the captured content when the at least one condition is true.

2. The method of claim 1, wherein the at least one condition comprises at least one of availability of a low priority network at the sending device and availability of a low priority network at the receiving device.

3. The method of claim 2, further comprising:
establishing a direct connection between the sending device and the receiving device; and
transferring the captured content directly from the sending device to the receiving device when a low priority network is available to the sending device and to the receiving device.

4. The method of claim 2, further comprising:
uploading the captured content to a server when a low priority network is available to the sending device; and
downloading the captured content from the server when a low priority network is available to the receiving device.

5. The method of claim 3, further comprising exchanging device capability information between the sending device and the receiving device over the direct connection.

6. The method of claim 4, further comprising sending a location of the captured content from the sending device to the receiving device after the sending device uploads the captured content to the server.

7. The method of claim 6, further comprising using the location of the captured content to download the captured content from the server.

8. A system for prioritizing file delivery, comprising:
a sending device having captured content;
a sending priority element configured to assign a sending priority to the captured content;
a network over which the captured file traverses when at least one condition is true; and
a receiving device configured to receive the captured content when the condition is true.

9. The system of claim 8, wherein the at least one condition comprises at least one of availability of a low priority network at the sending device and availability of a low priority network at the receiving device.

10. The system of claim 9, further comprising:
a direct connection between the sending device and the receiving device; and
a low priority network available to the sending device and to the receiving device over which to transfer the captured content directly from the sending device to the receiving device.

11. The system of claim 9, further comprising:
a server configured to receive the captured content when a low priority network is available to the sending device; and
the server configured to send the captured content to the receiving device when a low priority network is available to the receiving device.

12. The system of claim 10, wherein the direct connection is used to exchange device capability information between the sending device and the receiving device.

13. The system of claim 11, wherein a location of the captured content is sent from the sending device to the receiving device after the sending device uploads the captured content to the server.

14. The system of claim 13, wherein the location of the captured content is used as an identifier to download the captured content from the server.

15. A system for prioritizing file delivery, comprising:
means for capturing content at a sending device;
means for establishing a sending priority for the captured content;
means for sending the captured content when at least one condition is true; and
means for receiving the captured content when the at least one condition is true.

16. The system of claim 15, wherein the at least one condition comprises at least one of availability of a low priority network at the sending device and availability of a low priority network at the receiving device.

17. The system of claim 16, further comprising:
means for establishing a direct connection between the sending device and the receiving device; and
means for transferring the captured content directly from the sending device to the receiving device when a low priority network is available to the sending device and to the receiving device.

18. The system of claim 16, further comprising:
means for uploading the captured content to a server when a low priority network is available to the sending device; and
means for downloading the captured content from the server when a low priority network is available to the receiving device.

19. The system of claim 17, further comprising means for exchanging device capability information between the sending device and the receiving device over the direct connection.

20. The system of claim 18, further comprising means for sending a location of the captured content from the sending device to the receiving device after the sending device uploads the captured content to the server.

21. The system of claim 20, further comprising means for using the location of the captured content to download the captured content from the server.

22. A non-transitory computer-readable medium having computer code stored thereon for execution by a processor for prioritizing file delivery, comprising:
a first code segment for capturing content at a sending device;
a second code segment for establishing a sending priority for the captured content;
a third code segment for sending the captured content when at least one condition is true; and
a fourth code segment for receiving the captured content when the at least one condition is true.

23. The computer-readable medium of claim 22, wherein the at least one condition comprises at least one of availability of a low priority network at the sending device and availability of a low priority network at the receiving device.

24. The computer-readable medium of claim 23, further comprising:
a fifth code segment for establishing a direct connection between the sending device and the receiving device; and
a sixth code segment for transferring the captured content directly from the sending device to the receiving device when a low priority network is available to the sending device and to the receiving device.

25. The computer-readable medium of claim 23, further comprising:
a seventh code segment for uploading the captured content to a server when a low priority network is available to the sending device; and
an eighth code segment for downloading the captured content from the server when a low priority network is available to the receiving device.

26. The computer-readable medium of claim 24, further comprising a ninth code segment for exchanging device capability information between the sending device and the receiving device over the direct connection.

27. The computer-readable medium of claim 32, further comprising a tenth code segment for sending a location of the captured content from the sending device to the receiving device after the sending device uploads the captured content to the server.

28. The computer-readable medium of claim 27, further comprising an eleventh code segment for using the location of the captured content to download the captured content from the server.

29. A method for prioritizing file delivery, comprising:
capturing content at a sending device;
establishing a sending priority for the captured content; and
sending the captured content when a low priority network is available to the sending device.

30. The method of claim 29, further comprising receiving the captured content at a receiving device when a low priority network is available to the receiving device.

31. The method of claim 30, further comprising:
establishing a direct connection between the sending device and the receiving device; and
transferring the captured content directly from the sending device to the receiving device when a low priority network is available to the sending device and to the receiving device.

32. The method of claim 30, further comprising:
uploading the captured content to a server when the low priority network is available to the sending device; and
downloading the captured content from the server when a low priority network is available to the receiving device.

33. The method of claim 31, further comprising exchanging device capability information between the sending device and the receiving device over the direct connection.

34. The method of claim 32, further comprising sending a location of the captured content from the sending device to the receiving device after the sending device uploads the captured content to the server.

35. The method of claim 34, further comprising using the location of the captured content to download the captured content from the server.
